(19) United States
(12) Patent Application Publication
(10) Pub. No.: US 2015/0060413 A1
(43) Pub. Date: Mar. 5, 2015

(54) WIRE ALLOY FOR PLASMA TRANSFERRED WIRE ARC COATING PROCESSES

(71) Applicant: MAHLE Industries, Inc., Farmington Hills, MI (US)

(72) Inventor: Thomas SMITH, Muskegon, MI (US)

(73) Assignee: MAHLE INDUSTRIES, INC., Farmington Hills, MI (US)

(21) Appl. No.: 14/477,577

(22) Filed: Sep. 4, 2014

Related U.S. Application Data
(60) Provisional application No. 61/874,069, filed on Sep. 5, 2013.

(51) Int. Cl. B23K 10/02; B23K 35/32

(52) U.S. Cl. CPC B23K 10/027; B23K 35/327; B33Y 10/00; B33Y 70/00
USPC 219/76.16; 219/146.23

(57) ABSTRACT

A method of depositing a corrosion resistant material via a plasma transferred wire arc (PTWA) thermal spray method on the cylinder surface of heavy duty diesel internal combustion engines. The PTWA process uses a stainless steel hollow core wire that is filled with a metal oxide or carbide powder. The powder can be 100% chromium carbide.

### CROSS-REFERENCE TO RELATED APPLICATIONS

This application claims priority under 35 USC 119(e) of U.S. Provisional Application Ser. No. 61/874,069, filed on Sep. 5, 2013, the disclosure of which is herein incorporated by reference.

### FIELD OF THE INVENTION

This invention relates to a wire used in a coating that provides increased cylinder corrosion resistance in heavy-duty diesel internal combustion engines. A coating applied to a surface using single wire plasma transferred wire arc (PTWA) technology is superior in its corrosion resistance compared to the base metal used in cast engine blocks of heavy duty diesel internal combustion engines.

### BACKGROUND

Currently, the cylinder bore bearing surface of an engine block is coated with an alloy by carrying out arc wire spraying. Known arc wire spraying processes include a twin-wire arc spray (TWAS) process, in which two wires are fed to a spray head in such a manner that the electric current is transmitted across the wires, and a plasma transferred wire arc (PTWA). The PTWA method establishes an operating plasma in which a cathode and a free end of a single consumable wire melt and continuously feed a stream of molten metal particles and project the particles onto the target surface.

Due to extremely demanding operating conditions, present-day heavy duty diesel internal combustion engine blocks and cylinder liners are usually made from cast iron. A high sulfur content of diesel fuel and a phenomenon called exhaust gas recirculation within the cylinder combine to create an extremely corrosive environment within the cylinder of heavy duty diesel engines. A material that provides better corrosion resistance than the cast iron surface of the cylinder is required for extended service life of the engine. Therefore, it is advantageous to coat the cylinder liner bores using the wire arc deposition spraying process, which produces a coating that has a greater resistance to corrosion than the cast iron material, thus increasing the service life of the engine as compared with conventional linings composed of gray cast iron alloys.

Plasma transferred wire arc (PTWA) is often the preferred method for coating the cylinder liner. In the PTWA process, a continuously advancing feedstock material (usually in the form of a metal wire or rod) is melted by using a constricted plasma-arc to melt only the tip of the wire or rod (connected as an anodic electrode); the melted particles are then propelled to a target. The plasma is a high velocity jet of ionized gas, which is desirably constricted and focused about a linear axis by passing it through a nozzle orifice downstream of a cathode electrode. The high current arc, which is struck between the cathode electrode and the anodic nozzle, is transferred to the wire tip maintained also as an anode, or the high current arc can be transferred directly to the wire tip.

The coating applied to the cylinder surface via the PTWA process is essentially the same material that composes the feedstock wire. The feedstock wire can be composed of almost any material that is capable of being melted and accelerated via a forced gas stream.

### SUMMARY OF THE INVENTION

It is an object of the invention to provide a wire for use in the PTWA process that creates a coating having superior corrosion resistance, so that it can be used on cylinder liners for heavy-duty diesel engines.

This object is accomplished by a wire for PTWA coating processes having an outer layer composed of stainless steel, with a hollow inner core. The stainless steel is preferably 430 stainless steel, but other types could also be used. The inner core is filled with a powder that is comprised of metal oxides or carbides, particularly of chromium, tungsten, titanium, molybdenum and nickel. In a preferred embodiment, the hollow core is filled with a powder composed of 100% chromium carbide. The chromium carbide is preferably in powder form with a −325 mesh particle size, but other particles sizes would also be suitable.

During the plasma process, the powdered metals are added to the composition of the stainless steel wire and are completely homogenized in the plasma stream. This provides a consistent and uniform chemistry of the deposited material.

The invention also provides a method for coating a component using the PTWA process, in which the wire is a stainless steel wire having a hollow core filled with a metal oxide or carbide. The component is preferably a cylinder liner, and the hollow core is preferably filled with 100% chromium carbide. The ionization and plasma process is started by a high voltage discharge, which ionizes the plasma gas between the alloy wires, nozzle body and cathode.

In the method of the present invention, the alloy wire is fed into an apparatus designed to create a plasma. In addition to the plasma, a carrier gas is introduced into the plasma stream at a high pressure. In one embodiment of this invention, the ionization and plasma process is started by a high voltage discharge, which ionizes the plasma gas between the alloy wire, nozzle body, and cathode.

The plasma thus produced flows at high velocity through the plasma nozzle. In this case, the plasma gas is transported to the continuously fed alloy wire perpendicular to the nozzle, whereby the electrical circuit is closed.

In the PTWA process, the carrier gas accelerates the ionized metal produced from the alloy wire to the target to be coated. The accelerated metal ions impact the target surface and are mechanically bonded to the target surface via plastic deformation. The rapid deceleration of the metal particles striking the target surface release kinetic and thermal energy. This released energy provides the energy required to plastically deform the particles. The use of a stainless steel hollow core wire filled with a chromium carbide powder has been found to create an exceptionally corrosion resistant coating when applied via the PTWA process.

The present invention provides a novel wire and process for coating cylinder liners of heavy-duty diesel engines. The coating is highly corrosion-resistant, which extends the life of the cylinder liner and engine.

### BRIEF DESCRIPTION OF THE DRAWINGS

The following detailed description of specific embodiments can be best understood when read in conjunction with the following drawings.

In the drawings, where similar reference numbers are used to denote similar elements:

FIG. 1 is a cross sectional view of a outer sheath of the wire according to the present invention;

FIG. 2 is a cross sectional view of the present invention, illustrating the solid outer sheath of FIG. 1 and the hollow center of the wire filled with a ceramic component; and

FIG. 3 shows a schematic drawing of a PTWA spraying process.

### DETAILED DESCRIPTION OF THE PREFERRED EMBODIMENTS

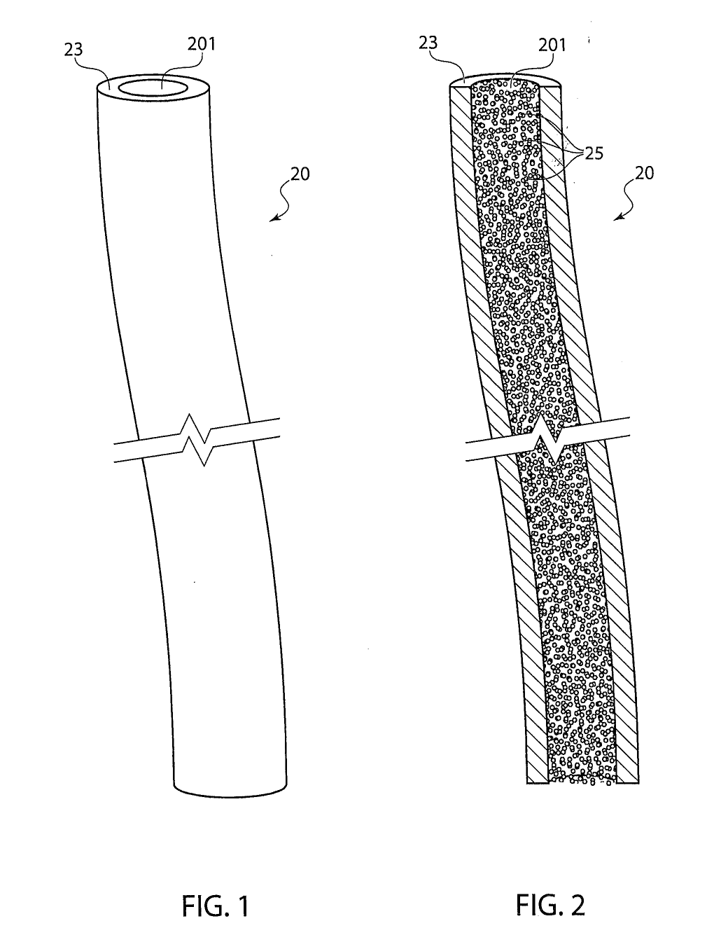

Referring in particular to the drawings, FIG. 1 shows a wire 20 of a specific stainless steel alloy and containing a hollow cavity 201 in the middle of the wire alloy strand 23. Wire alloy strand is preferably comprised of stainless steel, and most preferably of 430 stainless steel, but other suitable types of steel could also be used. 430 stainless steel is a non-hardenable steel containing straight chromium, and belongs to the ferritic group of steels. This steel is known for its good corrosion resistance.

As shown in FIG. 2, the hollow cavity 201 of wire strand 23 is filled with a metal oxide or carbide powder 25. In a preferred embodiment, powder 25 is 100% chromium carbide. The powder is preferably −325 mesh, but other particle sizes could also be used.

During the PTWA spraying process, the individual elements, i.e., the steel in wire 23 and the powder 25, are completely homogenized in the plasma stream. This provides a consistent and uniform chemistry of the deposited material.

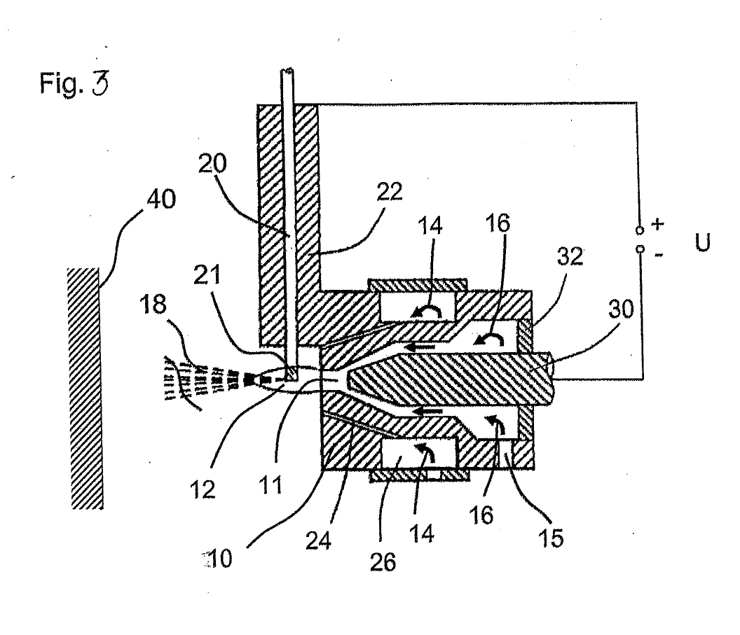

In the method according to the invention, a component, in particular, a cylinder liner of an internal combustion engine, which is produced or cast from aluminum or cast iron, is coated with an alloy formed from wire 20 during the PTWA process, as shown in FIG. 3.

With reference to FIG. 3, a schematic drawing of a conventional PTWA thermal spraying process is shown. Wire 20 is continuously fed into the heat source, where the material is at least partially molten. The electrically provided heat source thereof is a plasma or arc. The PTWA has a plasma generator or gun head comprising a nozzle 10 with a nozzle orifice 11, an electrically conductive consumable wire 20 connected as first electrode and a second electrode 30. The second electrode 30 is insulated to the nozzle 10 by an insulating body 32. Electric power is applied by the power source U as a direct current, whereas the positive potential is connected to the wire 20 and the negative potential is connected to a second electrode 30.

The wire 20 is fed perpendicularly to the center nozzle orifice 11 of the nozzle 10. The second electrode 30 is circulated by an ionized gas mixture also called gas plasma 16, provided by a plasma gas source 15. The plasma gas 16 exits the nozzle orifice 11 as a plasma jet 12 at high, preferably supersonic velocity and completes the electrical circuit when meeting the consumable wire 20 as first electrode.

Transport secondary gas 14 is added through secondary gas orifices 24 in the nozzle 10 surrounding the plasma jet 12. The secondary gas 14 works as secondary atomizer of the molten droplets formed from the wire 20 and support transferring the droplets as a metal spray 18 onto the target surface 40. Preferably the secondary gas 14 is compressed air.

Wire feed section 22 is mechanically connected to nozzle 10 and formed within the assembly. Wire feed section 22 made of isolating or non-isolating material holds the consumable wire 20. In operation of the apparatus, wire 20 is constantly fed by means known in the art, like wire feed rolls through feed guide. A free wire end 21 emerges from wire feed section 22 and contacts the plasma jet 12 opposite to the nozzle orifice 11 to form a metal spray 18. In operation, metal spray 18 is directed towards a surface 40 to be coated. Surface 40 is preferably a cast iron cylinder liner of a heavy-duty diesel engine.

The positive terminal of the power supply is connected to the wire 20 and the negative terminal is connected to second electrode 30. Simultaneously, the high voltage power supply is pulsed “on” for sufficient time to strike a high voltage arc between the second electrode 30 and the wire tip 21. The high voltage arc thus formed provides a conductive path for the DC current from the plasma power supply to flow from the second electrode 30 to the wire 20. As a result of this electrical energy, the plasma gas is intensely heated which causes the gas, which is in a vortex flow regime, to exit the nozzle orifice 11 at very high velocity, generally forming a supersonic plasma jet 12 extending from the nozzle orifice 11. The plasma arc thus formed is an extended plasma arc, which initially extends from the second electrode 30 through the core of the vortex flowing plasma jet 16 to the maximum extension point. The high velocity plasma jet 12, extending beyond the maximum arc extension point provides an electrically conductive path between the second electrode 30 and free end 21 of the wire 20.

A plasma is formed between second electrode 30 to wire 20, causing the wire tip to melt as it is being continuously fed into the plasma jet 12. A secondary gas 14 entering through openings 24 in the nozzle 10, such as air, is introduced under high pressure through peripheral openings 26 in the nozzle 10. This secondary gas is distributed to the series of spaced bores. The flow of this secondary gas 14 provides a means of cooling the wire feed section 22, nozzle 10, as well as providing an essentially conically shaped flow of gas surrounding extended plasma jet 12. This conically shaped flow of high velocity secondary gas intersects with the extended plasma jet 12 downstream of the free end 21 of wire 20, thus providing addition means of atomizing and accelerating the molten particles formed by the melting of wire 20 and creating the metal spray 18.

By using wire 20 according to the invention, which is formed of stainless steel with an inner core of 100% chromium carbide powder, a very effective corrosion resistant coating can be created. The powder mixes completely with the stainless steel during the plasma spraying process, creating a completely uniform, corrosion resistant coating on surface 40.

What is claimed is:

1. A wire for use in plasma transferred wire arc coating processes, wherein the wire is formed of stainless steel with a hollow inner core that is filled with a metal powder consisting of 100% chromium carbide.

2. The wire according to claim 1, wherein the stainless steel is 430 stainless steel.

3. The wire according to claim 1, wherein the metal powder has a particle size of approximately −325 mesh.

4. A method of coating a surface with a metal alloy, comprising performing a thermal spray coating process on the surface, wherein the coating process is performed using a wire formed of stainless steel with a hollow inner core that is filled with a metal powder consisting of 100% chromium carbide.

5. The method according to claim 4, wherein the thermal spray process is a plasma transferred wire arc process.

6. The method according to claim 4, wherein the stainless steel is 430 stainless steel.

7. The method according to claim 4, wherein the powder has a particle size of approximately −325 mesh.
